(19) United States
(12) Patent Application Publication
(10) Pub. No.: US 2023/0149964 A1
(43) Pub. Date: May 18, 2023

(54) SINGLE USE TABLE TOP SANITIZER DISPENSERS AND SELF-DETACHING DIP TUBES FOR SAME

(71) Applicant: GOJO Industries, Inc., Akron, OH (US)

(72) Inventors: John J. McNulty, Broadview Heights, OH (US); Jeffrey S. Louis, Akron, OH (US); Aaron D. Marshall, Silver Lake, OH (US)

(21) Appl. No.: 18/053,442

(22) Filed: Nov. 8, 2022

Related U.S. Application Data
(60) Provisional application No. 63/280,252, filed on Nov. 17, 2021.

(51) Int. Cl. B05B 15/30; B05B 11/00; A47K 5/12

(52) U.S. Cl. CPC B05B 15/30; B05B 11/3047; A47K 5/1205

(57) ABSTRACT

Exemplary table-top sanitizer dispensers and dip tube separation members are disclosed herein. An exemplary table-top sanitizer dispenser includes a container. The container has a neck that has an inside diameter. The container having an annular wall extending outward from the base of the neck. The table-top dispenser has pump that has a pump housing. The pump housing has an annular retention member at the bottom of the housing. A nozzle is secured to the pump housing. A closure is also secured to the pump housing. The table-top dispenser further includes a dip tube. The dip tube is secured to the annular retention member. A dip tube separation member extending outward from the dip tub is also included. The dip tube separation member has a biased state and an unbiased state. In the biased state the dip tube separation member has a diameter that is smaller than the inside diameter of the neck. When the separation member moves toward its unbiased state, the separation member is wider than the inside diameter of the neck. When the dip tube is connected to the annular retention member and the separation member is located inside of the container, removing the closure and the pump from the container causes the dip tube to separate from the annular retention member and the dip tube remains in the container.

### CROSS-REFERENCE TO RELATED APPLICATIONS

This application claims priority to and any benefit of U.S. Provisional Application No. 63/280,252, filed Nov. 17, 2021, the content of which is incorporated herein by reference in its entirety.

### TECHNICAL FIELD

The present invention generally relates to a device for preventing refilling of table-top sanitizer dispenser containers. More specifically, the invention relates to a device for detaching the dip tube to prevent removing and replacing the closure, pump and dip tube after refilling a single use table-top sanitizer dispenser container.

### BACKGROUND OF THE INVENTION

Current table-top hand sanitizer dispensers have a closure that screws onto the neck of a container. The closure connects a pump, a dip tube and dispenser nozzle to the container. Sometimes after the table-top hand sanitizer dispenser container is empty, a user unscrews the closure, removes the pump, dip tube and nozzle, refills the container, and screws the closure back on so the table-top dispenser can be reused. Often, the sanitizer that is used to refill the container is not the same as the original sanitizer. Accordingly, the ingredients in the table-top dispenser are not the ingredients listed on the container. Not only does this mislead and confuse customers as to the actual source of the sanitizer product, but it may be very harmful to users. For example, during the height of the corona virus pandemic, illegal, toxic and/or unregulated hand sanitizers were introduced into the market. Some of these illegal and unregulated hand sanitizers contain methanol, 1-propanol or other toxic additives, which are hazardous to consumers. Accordingly, a need exists to prevent refilling of containers of single use table-top dispensers.

### SUMMARY

Exemplary table-top sanitizer dispensers and dip tube separation members are disclosed herein. An exemplary table-top sanitizer dispenser includes a container. The container has a neck that has an inside diameter. The container having an annular wall extending outward from the base of the neck. The table-top dispenser has pump that has a pump housing. The pump housing has an annular retention member at the bottom of the housing. A nozzle is secured to the pump housing. A closure is also secured to the pump housing. The table-top dispenser further includes a dip tube. The dip tube is secured to the annular retention member. A dip tube separation member extending outward from the dip tub is also included. The dip tube separation member has a biased state and an unbiased state. In the biased state the dip tube separation member has a diameter that is smaller than the inside diameter of the neck. When the separation member moves toward its unbiased state, the separation member is wider than the inside diameter of the neck. When the dip tube is connected to the annular retention member and the separation member is located inside of the container, removing the closure and the pump from the container causes the dip tube to separate from the annular retention member and the dip tube remains in the container.

Another exemplary table-top sanitizer dispenser includes a container. The container has a neck. The neck has an inside diameter. A container surface extends outward from the bottom of the neck. The pump has a pump housing that has a dip tube connector at the bottom of the pump housing. A nozzle and a closure are secured to the pump housing. A dip tube is secured to the dip tube connector. A dip tube separation member extends outward from the dip tube. The dip tube separation member has a resilient body. The resilient body compresses to fit through the neck of the container. The resilient body expands upon passing through the neck of the container. After the closure, pump, dip tube and nozzle have been connected to the container, upward movement of the closure, pump, nozzle and dip tube connector causes the resilient body to engage with the surface extending outward from the bottom of the neck and causes the dip tube to separate from the dip tube connector.

Another exemplary table-top sanitizer dispenser includes a container having a neck that has an inside diameter and an annular wall that extends outward from the base of the neck. A pump is also included. The pump has a pump housing that has an annular retention member at the bottom of the pump housing. A nozzle and a closure are secured to the pump housing. A dip tube is secured to the annular retention member. Two or more resilient wings extend outward and upward from the dip tube. The two or more resilient wings biased outward. In their outward un-biased position the distance between the two or more wings is greater than the inside diameter of the neck and when the closure and the pump are separated from the container, the dip tube separates from the annular retention member and the dip tube remains in the container.

### BRIEF DESCRIPTION OF THE DRAWINGS

These and other features and advantages of the present invention will become better understood with regard to the following description, and accompanying drawings in which:

FIG. 1 is a prospective view of a prior art table-top sanitizer dispenser;

FIG. 2 is a prospective view of the table-top sanitizer dispenser with the closure, pump, dip tube and nozzle removed from the container;

FIG. 3 is a cross-sectional view of an exemplary embodiment of a table-top sanitizer dispenser with a dip tube separation member;

FIG. 4 is a prospective view of an exemplary embodiment of a dip tube having dip tube separation member;

FIGS. 5 and 6 are partial cross-sectional views of the closure, pump, dip tube and nozzle being connected to a container with the dip tube separation member partially through the neck;

FIG. 7 is a partial cross-sectional views of the closure, pump, dip tube having the dip tube separation member and nozzle connected to a container;

FIG. 8 is a cross-section of the closure, pump and nozzle being removed from the container and the dip tube separated from the closure;

FIG. 9 is a prospective view of another exemplary embodiment of a dip tube having dip tube separation member;

FIG. 10 is a prospective view of another exemplary embodiment of a dip tube having dip tube separation member;

FIG. 11 is a cross-sectional view of another exemplary embodiment of a dip tube having dip tube separation member;

FIG. 12 are two cross-sectional views of another exemplary embodiment of a dip tube having dip tube separation member;

FIG. 13 is a cross-sectional view of another exemplary embodiment of a dip tube having dip tube separation member;

FIG. 14 is a cross-sectional view of yet another exemplary embodiment of a dip tube having dip tube separation member; and

FIG. 15 is a partial cross-sectional view of yet another exemplary embodiment of a dip tube having dip tube separation member.

### DETAILED DESCRIPTION

The Detailed Description merely describes exemplary embodiments of the invention and is not intended to limit the scope of the claims in any way. Indeed, the invention is broader than and unlimited by the exemplary embodiments, and the terms used in the claims have their full ordinary meaning. In addition, the exemplar mythologies may include additional blocks or steps or may have some blocks or steps removed. Further, the blocks or steps may be performed in different orders.

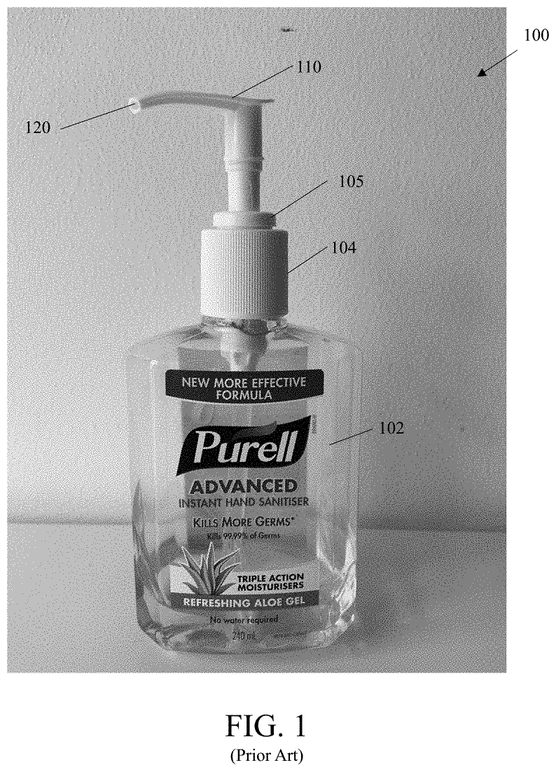

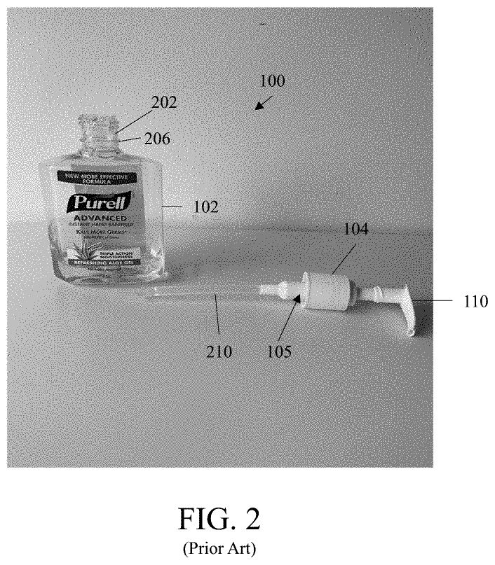

FIGS. 1 and 2 are a prospective views of a prior art table-top sanitizer dispenser 100. Table-top sanitizer dispenser 100 includes a container 102, a closure 104, a pump 105, dip tube 210 and an outlet nozzle 110. Closure 104 has female threads (not shown) that engage with and screw onto male threads 206 of neck 202. As can be seen in FIG. 2, closure 104 readily unscrews from neck 202 and the closure 104, pump 105, nozzle 110 and dip tube 210 separate from container 102. Once separated, container 102 may be refilled and the closure 104, pump 105, nozzle 110 and dip tube 210 may be reconnected to the container 102.

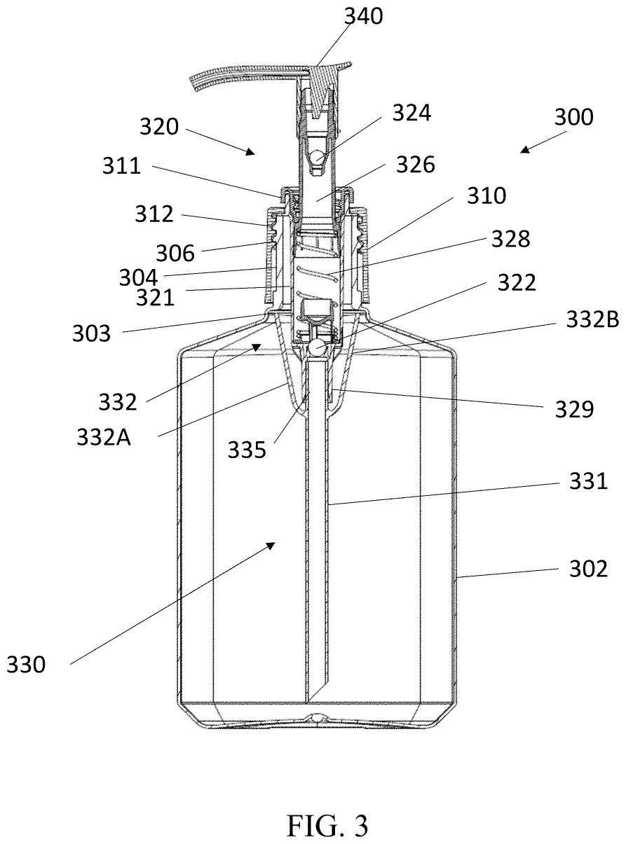

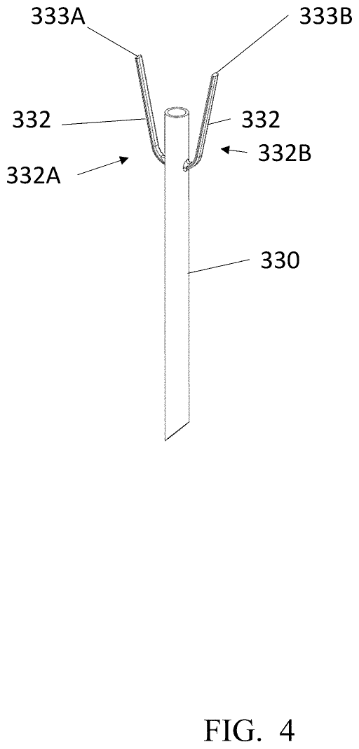

FIG. 3 is a cross-sectional view of an exemplary embodiment of a table-top sanitizer dispenser 300 and FIG. 4 is a prospective view of an exemplary embodiment of a dip tube having a dip tube separation member 332. Table-top sanitizer dispenser 300 has a container or container 302. Container 302 has a neck 304. Neck includes male threads 306. Located at the base of the neck is an annular wall 303. Annular wall 303 extends outward from the base of the neck 304.

Table-top sanitizing dispenser 300 includes a closure 310, a pump 320, an outlet nozzle 340, dip tube 330 and a dip tube separation member 332. Dip tube separation member 332 is an exemplary embodiment of an anti-refilling member. Pump 300 includes a pump housing 321, a pump chamber 326, a liquid inlet valve 322 and a liquid outlet valve 324. Nozzle 340 is secured to an upper portion of pump housing 321. Located at the bottom of pump housing 321 is a dip tube retention member 329. Pump housing 321 is connected to closure 310 by a chaplet 311.

Dip tube 330, which is a single use dip tube, has an elongated conduit 331 that extends from the pump housing 321 to the bottom of container 302. An upper portion 335 of the elongated conduit 331 extends into dip tube retention member 329. Located at an upper end of the elongated conduit 331 is a dip tube separation member 332. Dip tube separation member 332 is one or more members that have first position, which is at, or toward, un-biased position and a second position that is a biased position. In the first position, at least a portion of the one or more members have a width that is greater than the inside diameter of the neck 304. In the second position, the one or more members are configured to pass through the neck 304.

In this exemplary embodiment, dip tube separation member 332 has a pair of resilient wings 332A, 332B that extend outward and upward. Resilient wings 332A, 332B are biased outward. Resilient wings 332A, 332B include engagement members 333A, 333B. resilient wings 332A are configured to flex or deflect inward to a biased position to pass through neck 304. Once resilient wings 332A, 332B pass through the neck 304, they move outward toward their un-biased position. As resilient wings 332A, 332B move outward, engagement members 333A, 333B are located beneath annular wall 303. In some embodiments, engagement members 333A, 333B are in contact with annular wall 303.

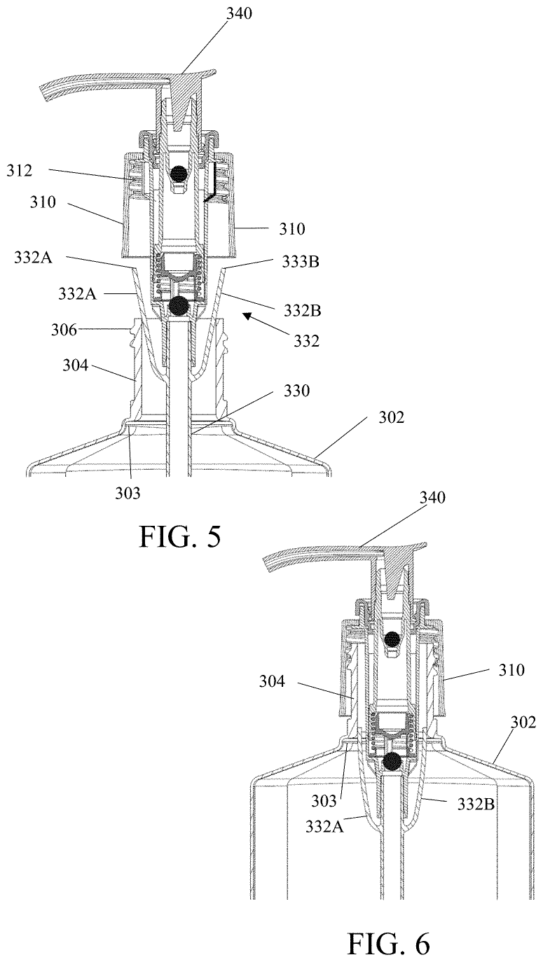

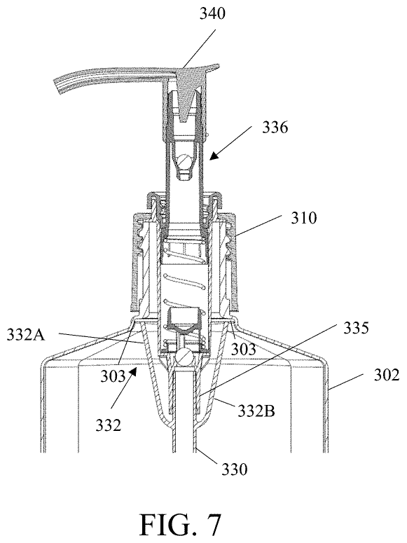

FIGS. 5 and 6 are partial cross-sectional views of the closure 310, pump 320, dip tube 330 and nozzle 340 being connected to a container 302. As seen in FIG. 4, wings 332A, 332B have an unbiased position wherein the engagement members 333A, 333B have a distance between them that is greater than the inside diameter of the neck 304. As can be seen in FIG. 6, wings 332A, 332B deflect to a biased state as they pass through neck 304. FIG. 7 illustrates the wings 332A, 332B expanded to, or toward, an unbiased state with engagement members 333A, 333B located outward of the neck 304 and below annular wall 303.

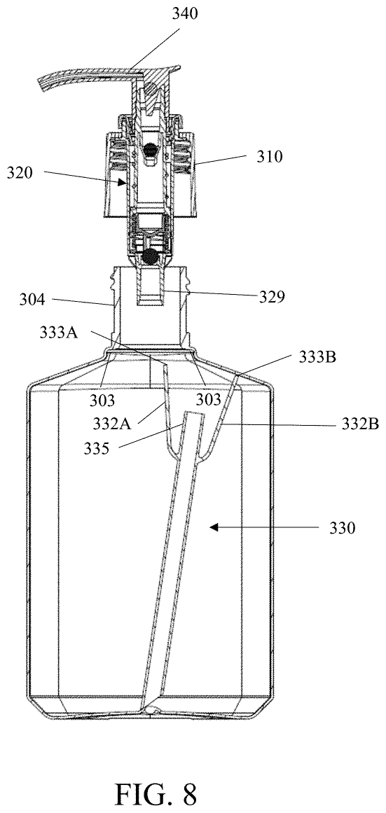

When closure 310 is unscrewed from neck 304, dip tube 330 is prevented from moving upward because engagement members 333A, 333B contact annular wall 303. As a result, upper portion 335 of elongated conduit 311 pulls out of dip tube retention member 329, which is shown in FIG. 8, as the closure 310, pump 320 and nozzle 340 are removed from the container 302, dip tube 330 remains in the container and cannot be easily removed. Thus, it would be difficult to refill and reuse sanitizer dispenser 300.

In some exemplary embodiments, dip tube separation member 332 has two or more wing members. In some embodiments, dip tube separation member 332 has three or more wing members. In some embodiments, dip tube separation member 332 has four or more wing members.

In some exemplary embodiments, dip tube separation member 332 has a single biased member, wherein the single biased member is configured to be biased inward to reduce its outside diameter or distance so that it fits through the neck, and expands or grows in outside diameter once it passes through the neck 304.

In some exemplary embodiments, dip tube separation member 332 extends radially outward from elongated conduit 330 and in some embodiments, extends upward from the bottom of the elongated conduit 330. In some exemplary embodiments, dip tube separation member 332 has a conical shape. In some exemplary embodiments, dip tube separation member 332 has a disc shape.

In some exemplary embodiments, dip tube 330 and/or dip tube retention member 329 has a fracture or plurality of partial fractures (not shown) in one of the upper portion 335 and the dip tube retention member 329. In that embodiment, rather than separating by pulling out, the upper portion 335 and/or the dip tube retention member 329 breaks off so that the elongated conduit 331 cannot be reconnected to the pump housing 321.

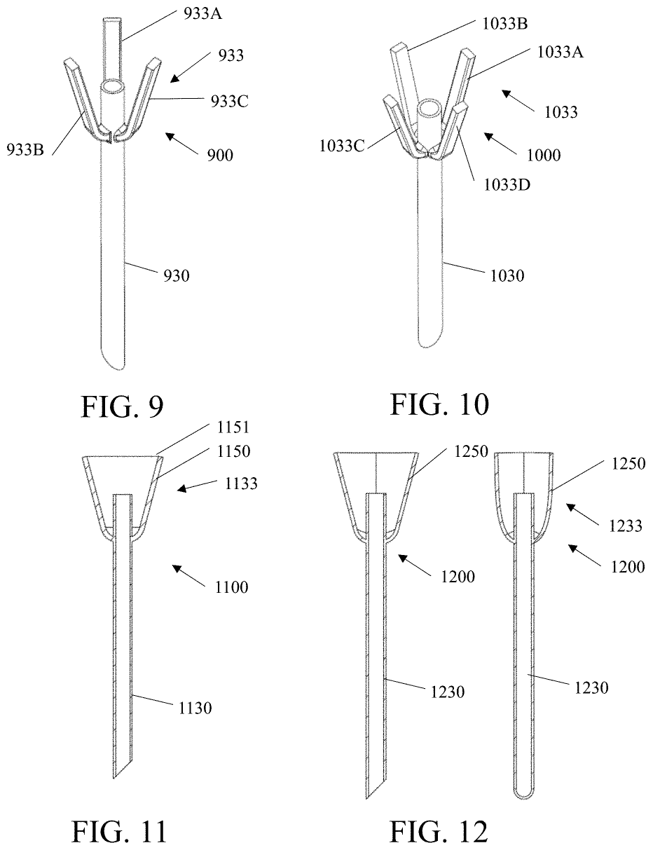

FIG. 9 is a prospective view of another exemplary embodiment of a dip tube 900 having dip tube separation member 933. In this exemplary embodiment dip tube separation member 933 includes a plurality of legs or wings 933A, 933B and 933C. Dip tube separation member 933 is located on an upper portion of elongated conduit 930.

FIG. 10 is a prospective view of another exemplary embodiment of a dip tube 1000 having dip tube separation member 1033. In this exemplary embodiment dip tube separation member 933 includes a plurality of legs or wings 1033A, 1033B, 1033C and 1033D. Dip tube separation member 1033 is located on an upper portion of elongated conduit 1030

FIG. 11 is a cross-sectional view of another exemplary embodiment of a dip tube 1100 having dip tube separation member 1133. Dip tube 1100 includes an elongated conduit 1130. Dip tube separation member 1133 has a conical shaped body 1150. Conical shaped body 1150 has a solid continuous upper surface 1151. Continuous upper surface 1151 has a circular shape. The conical shaped body 1150 is made of a flexible resilient material and compresses to pass through a neck of a bottle and expands so it cannot be easily pulled back up through the neck and causes the straw to separate from the pump.

FIG. 12 are two cross-sectional views of another exemplary embodiment of a dip tube 1200 having dip tube separation member 1233. Dip tube 1200 includes an elongated conduit 1230. Dip tube separation member 1233 has a body 1250. Body 1250 has a solid continuous upper surface 1251. Continuous upper surface 1251 has an oval shape. The body 1250 is made of a flexible resilient material and compresses to pass through a neck of a bottle and expands so it cannot be easily pulled back up through the neck and causes the straw to separate from the pump.

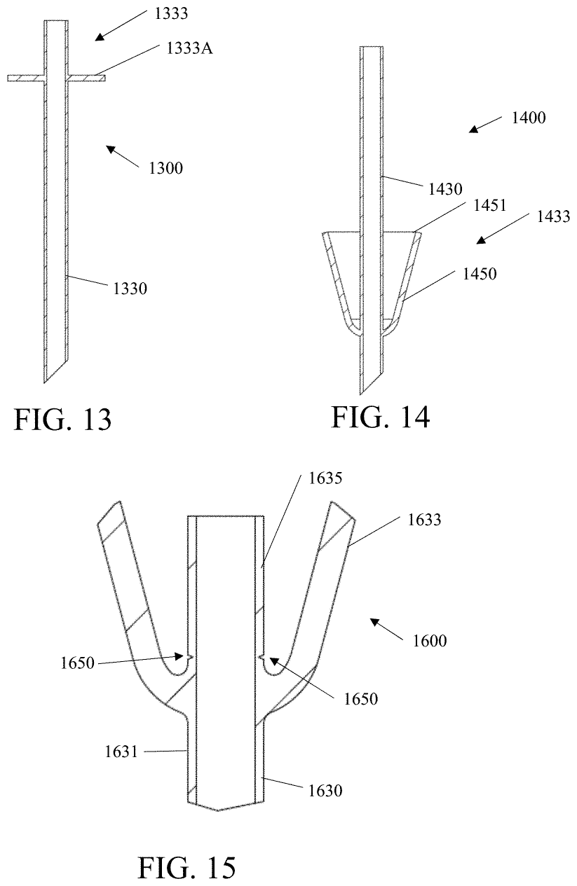

FIG. 13 is a cross-sectional view of another exemplary embodiment of a dip tube 1300 having dip tube separation member 1333. Dip tube has an elongated conduit 1330. Separation member 1333 is located on an upper portion of the elongated conduit 1330 and has a cylindrical disk 1333A. The body of cylindrical disk 1333A is made of a flexible resilient material and compresses to pass through a neck of a bottle and expands so it cannot be easily pulled back up through the neck and causes the straw to separate from the pump.

FIG. 14 is a cross-sectional view of yet another exemplary embodiment of a dip tube having dip tube 1400 separation member 1433. Dip tube 1400 includes an elongated conduit 1430. Dip tube separation member 1433 has a conical shaped body 1450. Conical shaped body 1450 has a solid continuous upper surface 1451. Continuous upper surface 1451 has a circular shape. The conical shaped body 1450 is made of a flexible resilient material and compresses to pass through a neck of a bottle and expands so it cannot be easily pulled back up through the neck and causes the straw to separate from the pump. In this exemplary embodiment, separation member 1433 is located at a lower position on dip tube 1430 but performs the same function and prevents the removal of the dip tube 1400.

FIG. 14 is a partial cross-sectional view of yet another exemplary embodiment of a dip tube 1600 having dip tube separation member 1633. This exemplary embodiment may take the form of any of the other embodiments. Dip tube 1600 includes an elongated conduit 1630. Elongated conduit 1630 has a lower portion 1631 and an upper portion 1635. Upper portion 1635 connects to the pump housing (not shown). Upper portion 1635 is designed to break away and/or separate from lower portion 1631. In this exemplary embodiment, one or more scores 1650 circle or at least partially circle elongated conduit 1630. The one or more scores 1650 are continuous, however, they may be intermittent or perforations. The one or more scores 1650 may be located below the receiving portion of the pump housing (not shown) when the dip tube 1600 is connected to the pump housing. In some embodiments, the one or more scores 1650 are located just above the receiving portion of the pump housing when dip tube 1600 is connected to the pump housing. Such a positioning may prevent leakage even if a portion of the one or more scores 1650 pass completely through the elongated conduit 1630. In some embodiments, the one or more scores 1650 are in the receiving portion of the pump housing (not shown). In some embodiments, the one or more scores 1650 are located on both the elongated conduit 1630 and the receiving portion of the pump housing. In some embodiments, the one or more scores 1650 are located in both the elongated conduit 1630 and the receiving portion of the pump housing and are aligned with each other. In some embodiments, the one or more scores 1650 are located in both the elongated conduit 1630 and the receiving portion of the pump housing and are off-set from one another. When the closure and pump (not shown) are removed from the container (not shown), the dip tube separation member 1630 prevents removal of the dip tube 1600 from the container. In some embodiments, the upper portion 1635 of the elongated conduit 1630 separates from the lower portion 1631. In some embodiments, a lower portion of the receiving portion of the pump housing (not shown) separates from an upper portion (not shown). In some embodiments, the upper portion 1635 of the elongated conduit 1630 separates from the lower portion 1631 and a lower portion of the receiving portion of the pump housing may separate from an upper portion.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

I/We claim:

1. A table-top sanitizer dispenser comprising:
a container;
the container having
a neck;
the neck having an inside diameter; and
an inner surface extending outward from the base of the neck;
a pump;
the pump having a pump housing;
the pump housing having an annular retention member at the bottom of the housing;
a nozzle secured to the pump housing;
a closure secured to the pump housing; and
a dip tube;
the dip tube secured to the annular retention member; and
a dip tube separation member extending outward from the dip tube;
the dip tube separation member having a biased state and an unbiased state;
wherein in the biased state the dip tube separation member has a diameter that is smaller than the inside diameter of the neck;
wherein when the dip tube separation member moves toward its unbiased state, the dip tube separation member is wider than the inside diameter of the neck; and
wherein when the dip tube is connected to the annular retention member and the separation member is located inside of the container, removing the closure and the pump from the container causes the dip tube to separate from the annular retention member and the dip tube remains in the container.

2. The table-top sanitizer dispenser of claim 1 wherein the dip tube separation member comprises two or more wings.

3. The table-top sanitizer dispenser of claim 2 wherein the two or more wings extend outward and upward from the dip tube.

4. The table-top sanitizer dispenser of claim 2 wherein the two or more wings further comprise two or more engagement members.

5. The table-top sanitizer dispenser of claim 1 wherein at least one of the dip tube and the annular retention member have a weak point configured to break-away when the dip tube separates from the annular retention member.

6. The table-top sanitizer dispenser of claim 1 wherein the dip tube separation member extends radially outward from the dip tube.

7. The table-top sanitizer dispenser of claim 1 wherein the dip tube separation member is a single piece and has a continuous outer edge that extends radially outward from the dip tube.

8. The table-top sanitizer dispenser of claim 7 wherein the dip tube separation member extends radially upward.

9. The table-top sanitizer dispenser of claim 1 wherein the dip tube separation member has a conical shape.

10. A table-top sanitizer dispenser comprising:
a container;
the container having
a neck;
the neck having an inside diameter; and
a surface extending outward from the bottom of the neck;
the pump having a pump housing;
the pump housing having a dip tube connector at the bottom of the housing;
a nozzle secured to the pump housing;
a closure secured to the pump housing; and
a dip tube;
the dip tube secured to the dip tube connector; and
a dip tube separation member extending outward from the dip tube;
the dip tube separation member having a resilient body;
wherein the resilient body compresses to fit through the neck of the container;
wherein the resilient body expands upon passing through the neck of the container; and
wherein after the closure, pump, dip tube and nozzle have been connected to the container, upward movement of the closure, pump, nozzle and dip tube connector causes the resilient body to engage with the surface extending outward from the bottom of the neck and causes the dip tube to separate from the dip tube connector.

11. The table-top sanitizer dispenser of claim 10 wherein the resilient body comprises two or more wings.

12. The table-top sanitizer dispenser of claim 11 wherein the two or more wings extend outward and upward from the dip tube.

13. The table-top sanitizer dispenser of claim 10 wherein at least one of the dip tube and the annular retention member have a weak point configured to break-away when the dip tube separates from the annular retention member.

14. The table-top sanitizer dispenser of claim 10 further comprising a hand sanitizer fluid in the container.

15. The table-top sanitizer dispenser of claim 10 wherein the resilient body is a single piece and has a continuous outer edge that extends radially outward from the dip tube.

16. The table-top sanitizer dispenser of claim 10 wherein the resilient body extends radially upward.

17. The table-top sanitizer dispenser of claim 10 wherein the resilient body has a conical shape.

18. A table-top sanitizer dispenser comprising:
a container;
the container having
a neck;
the neck having an inside diameter; and
an annular wall extending outward from the base of the neck;
a pump;
the pump having a pump housing;
the pump housing having an annular retention member at the bottom of the housing;
a nozzle secured to the pump housing;
a closure secured to the pump housing; and
a dip tube;
the dip tube secured to the annular retention member; and
two or more resilient wings extending outward and upward from the tube;
the two or more resilient wings biased outward;
wherein in their outward un-biased position the distance between the two or more wings is greater than the inside diameter of the neck; and
wherein when the closure and the pump are separated from the container, the dip tube separates from the annular retention member and the dip tube remains in the container.

19. The table-top sanitizer dispenser of claim 18 wherein the two or more wings further comprise two or more engagement members.

20. The table-top sanitizer dispenser of claim 18 further comprising a hand sanitizer fluid in the container.
